(19) United States
(12) Patent Application Publication
(10) Pub. No.: US 2009/0277955 A1
(43) Pub. Date: Nov. 12, 2009

(54) SYSTEM AND METHOD TO INDEX MACHINE-READABLE CODES AND CORRELATE THE DATA FOR DELIVERING PRODUCT SPECIFIC VIDEOS ON COMPUTER SYSTEMS AND DEVICES

(75) Inventors: Brainerd Sathiananthan, San Jose, CA (US); Vibhash Trivedi, Sunnyvale, CA (US)

Correspondence Address: DLA PIPER LLP (US ), 2000 UNIVERSITY AVENUE, EAST PALO ALTO, CA, 94303-2248, US

(73) Assignee: Avot Media, Inc., San Jose, CA (US)

(21) Appl. No.: 11/941,497

(22) Filed: Nov. 16, 2007

(51) Int. Cl. G06F 19/00

(52) U.S. Cl. 235/375

(57) ABSTRACT

A system and method for indexing machine-readable codes and for correlating the readable code data in order to deliver product specific videos and computer systems and devices. The ability to capture and search machine-readable information across an index is very powerful. The system brings a highly used consumer video concept into the retail product world in an extremely efficient manner.

### FIELD

The system and method is directed to a system that uses machine readable codes.

### BACKGROUND

Using a machine-readable code to identify products is a widely used phenomenon across the world. In fact, every product we buy, use and/or consume has a machine-readable code associated with it. There are many different types of known machine-readable codes that are in use today including: 1) one-dimensional bar codes; 2) two-dimensional bar codes; 3) Quick Response codes and the like.

As the number of machine-readable codes increases, there needs to be a system that indexes and correlates this information to the consumer and to the products. Such information is maintained in large databases today by the various organizations that are responsible for assigning codes to various retailers. However such databases cannot be easily searched by the consumer and be correlated with other products and trends in a meaningful manner.

The search and correlation brings numerous benefits to retail products, namely the ability to delivery demonstration videos explaining the usage of the product, on demand user video reviews, connect with similar users of the product at the time of purchase.

Mobile video is an emerging field with users consuming premium and user generated video content. The concept of using machine-readable codes attached to objects and being able search through a large repository of such codes efficiently and delivering associated video on demand is a very beneficial to the end consumer and thus it is desirable to provide a system and method for indexing machine readable codes and correlate the machine readable codes and it is to this end that the system and method are directed.

### BRIEF DESCRIPTION OF THE DRAWINGS

FIG. 1 illustrates an example of the architecture of an implementation of a machine readable code system;

FIG. 2 illustrates an example of the architecture of an implementation of an indexing system that is part of the machine readable code system shown in FIG. 1;

FIG. 3 illustrates an example of the architecture of an implementation of a product correlation system that is part of the machine readable code system shown in FIG. 1; and

FIG. 4 illustrates an example of user interface of a product screen on a computing device of the machine readable code system.

### DETAILED DESCRIPTION OF ONE OR MORE EMBODIMENTS

The system and method are particularly applicable to a web-based system that delivers product specific data to a computing device and reads quick response type codes and it is in this context that the system and method are described. It will be appreciated, however, that the system and method has greater utility since it can be used with other computer system architectures, with various computing devices and may be used with various different types of machine readable codes.

A system and method for indexing and correlate machine-readable codes is provided that reads machine-readable codes which are widely associated with retail and wholesale goods. This system and method connects the machine-readable codes with modern search engine mechanism to deliver associated content faster and in an efficient manner. In one embodiment, the method may include the users entering machine-readable code information on their mobile phones or taking a camera snapshot of the machine readable code so that the code information is then sent to a correlation system that delivers associated product video information relating to the machine-readable code back to the mobile phone. The correlation system enables a user to search and correlate the machine-readable code to perform targeted video content delivery. Thus, the system and method turns a mobile device of the user (or any other computing device) into a powerful product helper system that enables users to search and discover products.

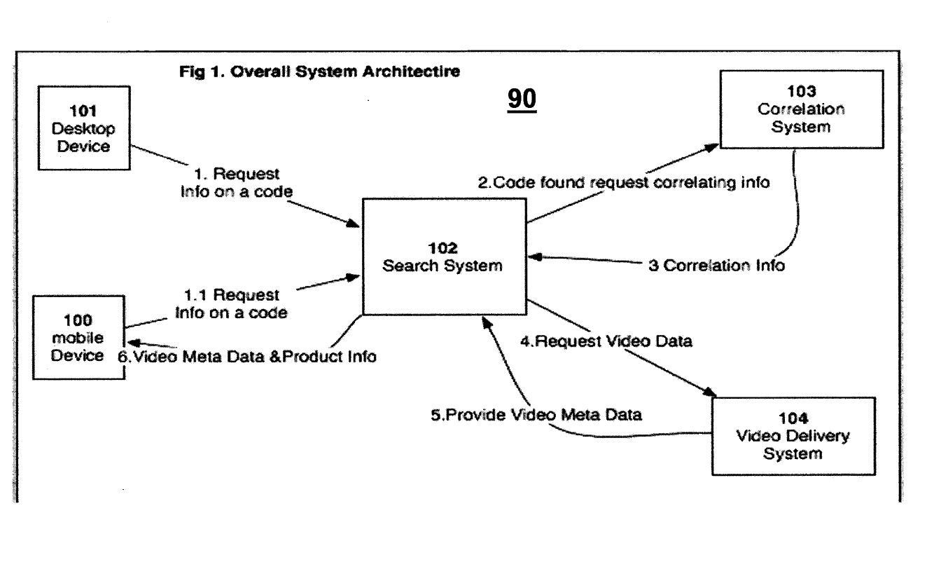

FIG. 1 illustrates an example of the architecture of an implementation of a machine readable code system 90. The system 90 may include one or more computing devices, such as a mobile device 100 or a desktop computer 101, that interact with a search system 102 that are then coupled to a correlation system 103 (with an associated storage unit having correlation data including similar product data and user consumption pattern data) and a video delivery system 104 (with an associated storage unit having video data including video data with links and video related metadata) with all of the elements being capable of being coupled to each other over a communications link (not shown). The communications link may be a computer network such as the Internet or a communications network such as digital telephone network. Each computing device is a processing unit based device with sufficient storage and connectivity to interact with the search system 102, such as a personal computer with a digital camera, a cellular phone with a digital camera, a mobile phone with a digital camera, a wireless email device with a digital camera, etc.. In one embodiment, each computing device may execute a browser application to interact with the search system. In one embodiment, the search system 102 may be one or more known server computers that communicate with the computing devices using a known protocol, such as HTTP or HTTPS, deliver web pages or WAP pages to the computing devices and receive data from the computing devices in a form in a web page and by other means and execute a plurality of lines of computer code to implement the functions and operations of the search system as described below. The correlation system and video delivery system may both be implemented as one or more server computers that execute a plurality lines of computer code to implement the functions described below of the correlation and video delivery system. The computing devices may also have an image capture device associated with the computing device or integrated into the computing device that may be used to capture an image of the machine readable code.

Returning to FIG. 1, users of the system, browsing using their computing devices, may capture a machine-readable code through various methods such as an attached machine-readable code scanner, mobile phone or a fixed camera captured image and/or manual user entry. The computing device may then send the captured machine readable code information to the search system 102 via the Internet or other communication links and thus request information about the machine readable code (1 and 1.1).

The search system 102 may include a storage unit that contains a plurality of pieces of machine readable code data and at least one product associated with each machine readable code that is contained in the storage unit and a plurality of pieces of video data associated with particular products. Thus, when the search system 102 receives the machine readable code information from a computing device, the search system 102 may then look for this machine-readable code in the data in the storage unit to determine if the machine readable code is in the storage unit and to identify any product information associated with the machine readable code. If the search system finds a match, it will take that information to query its video related index to find out any video data that matches the product data. Once a match is found, all of the matching information is sent to the correlation system 103 to correlate and recommend similar product based on the users consumption pattern. In the system, there are several functions that are exposed by the correlation system that is invoked by the search system. The functions may include: AddUserForCorrelation (user,id) which is a template function to keep track of the user during correlation and to correlate the information; AddVideoForCorrelation (userid, codeid, video_id) which is a function that inserts the userid, codeid and video identification to the correlation system wherein the correlation system learns from this input; and GetCorrelatedVideos (userid, codeid) which is a function that provides an XML list of videos that correlate to the user and the machine readable code.

Once the correlation information is found, the appropriate video links and related metadata such as thumbnails, description, number of views, etc may be fetched from the video delivery system 104. An example of the video metadata may be: video title character (255), video description character (2048), original source character (255), number of views (integer) and Thumbnail character (255); and an example of the video data may be: video length (time), video codec type (integer), audio codec type (integer), video data (binary) and audio data (binary). Then, the appropriate video links and related metadata are sent back to the computing device(s) by the search system 102 over the communication link. When the user selects the appropriate video to view, this video is delivered directly to the computing device being used by the user from the video delivery system 104.

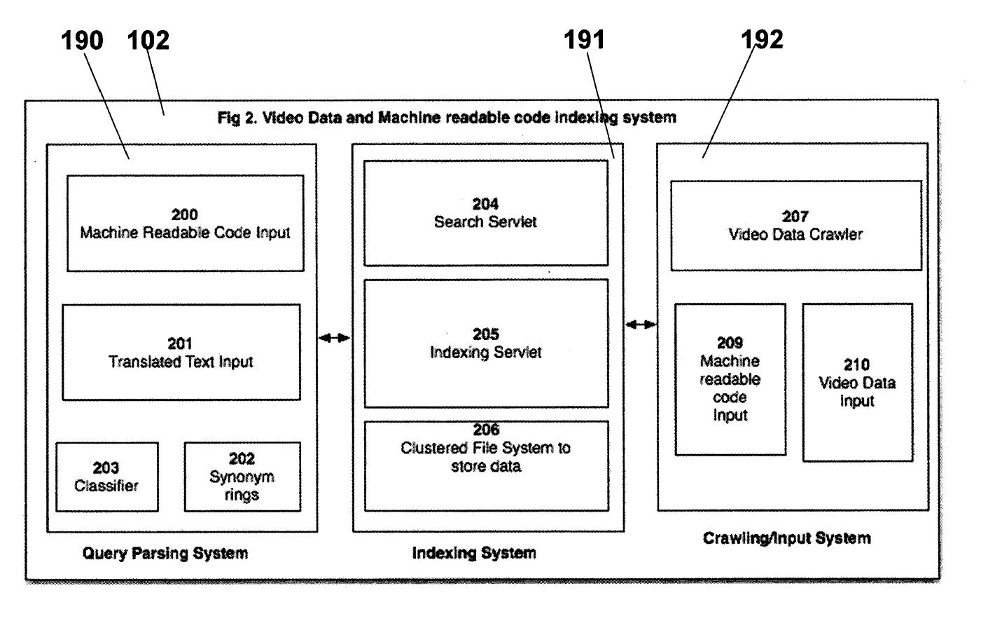

FIG. 2 illustrates an example of the architecture of an implementation of an indexing system that is part of the machine readable code system shown in FIG. 1. In particular, the indexing system is part of the search system 102 shown in FIG. 1. The search system is broken into three main sections including a Query Parsing System 190, an Indexing System 191 and a Crawling\Input System 192. The Query Parsing System 190, Indexing System 191 and Crawling\Input System 192 may each be implemented as a plurality of lines of computer code executed by a processing unit of the search system's one or more server computers. The operation begins with a user query (with the machine readable code information) is input into the query parsing system 190. In one embodiment, the user query may be in the form of a URL request. In certain cases, the input query may also be an image (an image of the machine readable codes) or an embedded link. Typically, the query consists of a string of numeric characters. However if the querying device is a mobile phone with limited capabilities, then the query will contain the still image captured by the camera and the query parsing system will perform the appropriate recognition and identify the corresponding machine-readable code (201). In the case of an embedded link or other type textual queries, such queries will be passed through an appropriate synonym ring (202), stemming routines and a classifier (203) to build a proper context of the query to generate expanded text for the query.

The resulting expanded text then may be sent to a search servlet (204) that is part of the indexing system 191, which then will take that query and perform a search across its inverted index of product video information in a clustered file system 206. Once a set of matching entries is found they are correlated with the video correlation system to find recommendations and personalization information.

Various crawlers that gather information from the Internet and other business data sources to build the index over a period of time. The crawlers will crawl video related sites on the Internet to gather video information (207). The machine-readable code information is the input into the indexer system (209). Furthermore, product related information is gathered from various product databases on the Internet (210). The indexes may be stored on a clustered file system. The clustered file-system connects the individual file systems across all the servers to appear as one single large file system (206) in a well known manner. The crawl information is posted to the indexing servlet (205). This indexing servlet receives the information, and then writes this to an inverted index table. The inverted index table consists of a list of words, corresponding link lists of documents and their frequencies that match these words. The system maintains several indexes for storing different types of data. In one embodiment, machine and product data will be maintained on a separate index from the video data. During a search query, data is searched from index and the resulting data is then input as query to search the second index.

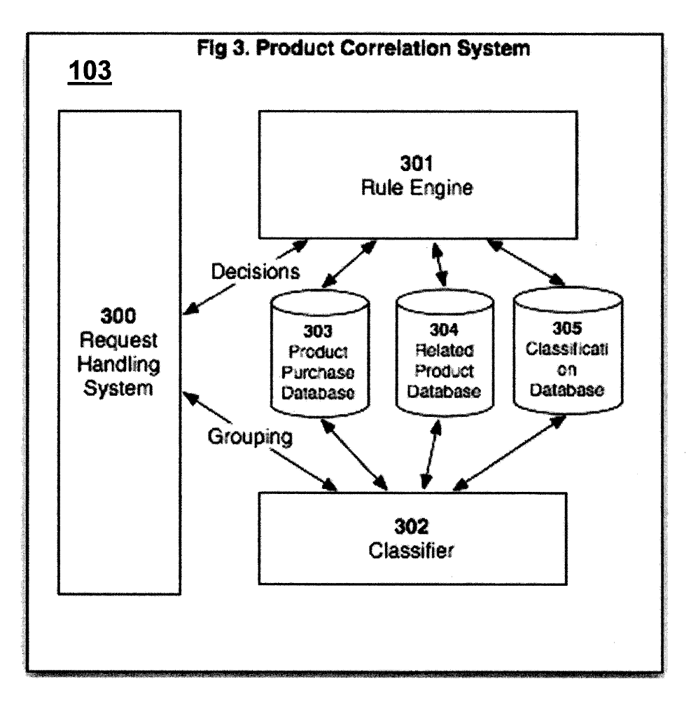

FIG. 3 illustrates an example of the architecture of an implementation of a product correlation system 103 that is part of the machine readable code system shown in FIG. 1. In particular, once a list of videos that match a product is found, this information is passed to the correlation system 103 that is a learning system capable of learning a user trend based on the search queries. The correlation system 103 may include a request handler system, 300 that handles the incoming and outgoing correlation information and a rule engine 301 that is associated with it and that dictates business logic information about various search terms. The rule engine is aided on its operation through several databases including a product purchase database 303, a related product database 304 and a classification database 305. The product purchase database may store data with the format {productid, codeid, description, categoryid} such as {567, BOOW79GQA, “Blackberry Curvey Titanium Phone 8320”, 664}. The related product database may store data with the format {productid, categoryid} such as {5567, 664} or {6687, 664}. The classification database may store data with the format {classid, productid} such as {8320, 664}.

A classifier 302 gathers its information from the classification databases and the output from the classifier is used by the rule engine to make smart recommendation decisions that are returned to the request handling system 300 that communicates the decisions back to the other parts the system. For example, the pseudocode for the classifier operation may be:

```
Input code/product id: 664 (Blackberry device 8320)
Output:
<category> Mobile Phones </category>
<Devices>
  <device product = “Blackberry 8300” id = 665>
  <device product = “Motorola KRZR K1” id = 345>
</Devices>
```

In some embodiments, regression Analysis based statistical techniques are employed to enhance the recommendation. In particular, various user searches are gathered and graphed using regression to find a trend, as new search results come through this trend is constantly adjusted to get better results.

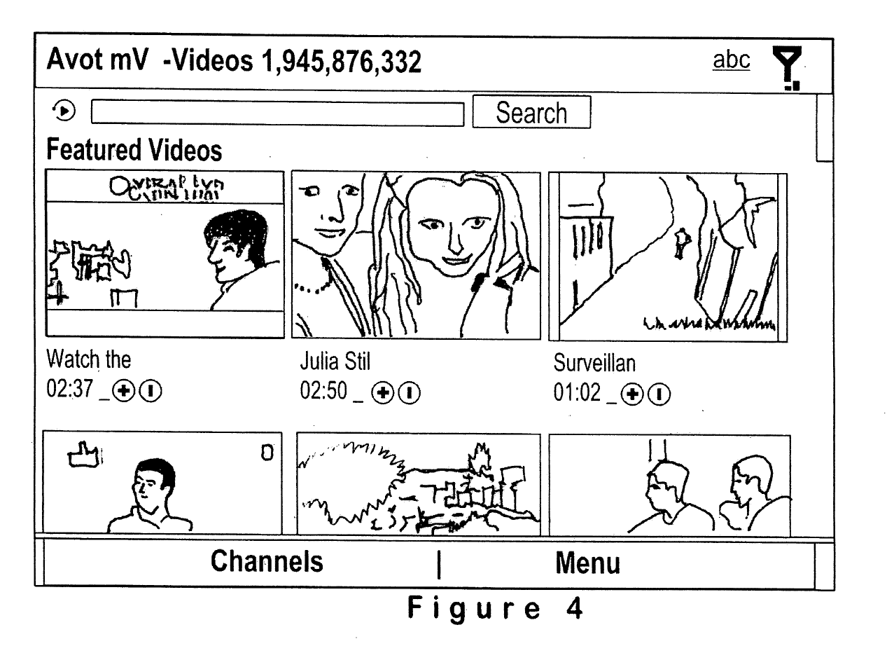

FIG. 4 illustrates an example of user interface 400 of a product screen on a computing device of the machine readable code system. In particular, the user interface permits a user of a mobile device to capture machine-readable code information. In operation, the user may input a one dimensional or two dimensional bar code through a search box or through image capture. The bar code information then passes through systems 102, 103, 104 and a list of videos is output that are relevant or match that product. The list of matches will be provided as an XML list that contains the metadata (described above) for each matching video.

While the foregoing has been with reference to a particular embodiment of the invention, it will be appreciated by those skilled in the art that changes in this embodiment may be made without departing from the principles and spirit of the invention, the scope of which is defined by the appended claims.

1. A system for indexing machine readable codes, comprising:
a query parsing unit that receives an incoming machine readable code and generates a query based on the incoming machine readable code;
a crawling unit that locates content with content information and product information and stores the content information and product information in an index that is stored in a storage unit; and
an indexing unit that receives the query and searches the index based on the query to identify content based on the content information and product information, that matches the incoming machine readable code.

2. The system of claim 1 further comprising a correlation module that correlates the matches to the incoming machine readable code with a set of correlation information.

3. The system of claim 2, wherein the correlation module further comprises a rule engine that generates a recommendation based on the set of correlation information.

4. The system of claim 1 further comprising one or more computing devices wherein each computing device is capable of capturing a machine readable code that is sent to the query processing unit.

5. The system of claim 4, wherein each computing device further comprises a desktop computer or a mobile device.

6. The system of claim 5, wherein the mobile device further comprising a digital camera.

7. The system of claim 5 further comprising a content delivery unit that delivers a piece of content to the mobile device.

8. The system of claim 1, wherein the piece of content further comprises a video.

9. A method for indexing machine readable codes and correlating the machine readable codes to deliver a piece of content, the method comprising:
receiving a request for information about a particular machine readable code from a computing device;
determining if the particular machine readable code appears in an index wherein the index contains a plurality of machine readable codes and a product associated with each machine readable code;
retrieving, when the particular machine readable code appears in the index, a set of correlation information that matches the particular machine readable code and identifies at least one piece of content;
retrieving, from a content delivery system, a set of content metadata; and
sending the set of content metadata and product information to the computing device.

10. The method of claim 9 further comprising delivering a piece of content to the computing device in response to the request for information about the particular machine readable code.

11. The method of claim 9 further comprising capturing, at the computing device, the particular machine readable code.

12. The method of claim 11, wherein capturing the particular machine readable code further comprising using a digital camera associated with the computing device to capture an image of the particular machine readable code.
